(19) United States
(12) Patent Application Publication
(10) Pub. No.: US 2017/0214081 A1
(43) Pub. Date: Jul. 27, 2017

(54) SOLID ELECTROLYTE COMPOSITION, METHOD FOR PRODUCING SAME, METHOD FOR PRODUCING SOLID ELECTROLYTE-CONTAINING LAYER, ELECTROLYTE LAYER, AND BATTERY

(71) Applicant: IDEMITSU KOSAN CO., LTD., Chiyoda-ku (JP)

(72) Inventors: Toshiaki TSUNO, Sodegaura-shi (JP); Hiroyuki TAMURA, Sodegaura-shi (JP)

(73) Assignee: IDEMITSU KOSAN CO., LTD., Chiyoda-ku (JP)

(21) Appl. No.: 15/327,913

(22) PCT Filed: Jul. 23, 2015
(86) PCT No.: PCT/JP2015/003700

§ 371 Date: Jan. 20, 2017

(30) Foreign Application Priority Data
Jul. 23, 2014 (JP) 2014-149869

(51) Int. Cl. H01M 10/056; C01B 17/36; H01M 10/0525; C01B 17/22

(52) U.S. Cl. CPC H01M 10/056; C01B 17/22; C01B 17/36; H01M 10/0525; C01P 2006/40; H01M 2300/0091

(57) ABSTRACT

A solid electrolyte composition comprising: a solid electrolyte that comprises Li; and a solvent represented by the following formula (1). R₁—(C═O)—R₂ (1) wherein in the formula (1), R₁ and R₂ are independently a hydrocarbon group including 2 or more carbon atoms.

### TECHNICAL FIELD

The invention relates to a solid electrolyte composition, a method for producing the same, a method for producing an electrolyte-containing layer, an electrolyte layer and a battery.

### BACKGROUND ART

In recent years, there has been an increasing demand for a lithium ion secondary battery used in a personal digital assistant, a portable electronic device, a household small power storage device, an automatic bicycle powered by a motor, an electric car, a hybrid electric car or the like.

As the method for ensuring security of a lithium ion secondary battery, an all-solid secondary battery obtained by using an inorganic solid electrolyte instead of an organic electrolyte solution has been studied.

In the production of a battery obtained by using an inorganic solid electrolyte, a solid electrolyte layer may be formed by applying a solid electrolyte composition in the form of a slurry (Patent Documents 1 to 7). However, if a solid electrolyte is mixed with a solvent to be in the form of a slurry, a problem arises that the ionic conductivity of the solid electrolyte is lowered under certain circumstances.

### RELATED ART DOCUMENTS

### Patent Documents

Patent Document 1: JP-A-2010-113820

Patent Document 2: JP-A-2012-151096

Patent Document 3: JP-A-2012-204114

Patent Document 4: JP-A-2013-062228

Patent Document 5: JP-A-2012-212652

Patent Document 6: JP-A-2012-199003

Patent Document 7: JP-A-2012-252833

### SUMMARY OF THE INVENTION

An object of the invention is to provide a solid electrolyte composition that can suppress lowering in ionic conductivity of a solid electrolyte.

According to the invention, the following solid electrolyte composition or the like are provided.

1. A solid electrolyte composition comprising:

a solid electrolyte that comprises Li; and

a solvent represented by the following formula (1):

R₁—(C═O)—R₂ (1)

wherein in the formula (1), R₁ and R₂ are independently a hydrocarbon group including 2 or more carbon atoms.

2. The solid electrolyte composition according to 1, wherein R₁ and R₂ are independently an aliphatic hydrocarbon group.
3. The solid electrolyte composition according to 2, wherein R₁ and R₂ are independently a saturated aliphatic hydrocarbon group.
4. The solid electrolyte composition according to 3, wherein R₁ and R₂ are independently a chain-like saturated aliphatic hydrocarbon group.
5. The solid electrolyte according to any one of 1 to 4, wherein R₁ and R₂ are the same.
6. The solid electrolyte composition according to 4 or 5, wherein R₁ and R₂ are independently a straight-chain saturated aliphatic hydrocarbon group.
7. The solid electrolyte composition according to any one of 1 to 6, wherein R₁ and R₂ are independently a hydrocarbon group including 5 or less carbon atoms.
8. The solid electrolyte composition according to any one of 1 to 7, wherein R₁ and R₂ are independently a hydrocarbon group including 3 or less carbon atoms.
9. The solid electrolyte composition according to any one of 1 to 8, wherein the solid electrolyte comprises Li, P and S.
10. The solid electrolyte composition according to 9, wherein, when Li, P and S are converted into Li₂S and P₂S₅, the molar ratio of Li₂S and P₂S₅ is Li₂S:P₂S₅=60:40 to 82:18.
11. The solid electrolyte composition according to any one of 1 to 10, wherein the weight ratio of the solid electrolyte and, the solvent is solid electrolyte:solvent=1:0.3 to 15.0.
12. The solid electrolyte composition according to any one of 1 to 11, which further comprises a binder.
13. The solid electrolyte composition according to 12, wherein the binder is a copolymer comprising a polymerization unit based on vinylidene fluoride and a polymerization unit based on hexafluoropropylene.
14. A method for producing a solid electrolyte composition which comprises mixing a solid electrolyte that comprises Li and a solvent represented by the following formula (1):

R₁—(C═O)—R₂ (1)

wherein in the formula (1), R₁ and R₂ are independently a hydrocarbon group including 2 or more carbon atoms.

15. The method for producing a solid electrolyte composition according to 14, which further comprises mixing a binder.
16. The method for producing a solid electrolyte composition according to 15, wherein the binder is a copolymer which comprises a polymerization unit based on vinylidene fluoride and a polymerization unit based on hexafluoropropylene.
17. A method for producing a solid electrolyte-containing layer, which comprises using the solid electrolyte composition according to any one of 1 to 13.
18. An electrolyte layer comprising a solid electrolyte which comprises Li, wherein said electrolyte layer comprises a solvent represented by the following formula (1):

R₁—(C═O)—R₂ (1)

wherein in the formula (1), R₁ and R₂ are independently a hydrocarbon group including 2 or more carbon atoms.

19. A battery which comprises an electrolyte layer, a positive electrode layer and a negative electrode layer, wherein at least one layer of the electrolyte layer, the positive electrode layer and the negative electrode layer comprises a solid electrolyte comprising Li and a solvent represented by the following formula (1):

R₁—(C═O)—R₂ (1)

wherein in the formula (1), R₁ and R₂ are independently a hydrocarbon group including 2 or more carbon atoms.

According to the invention, it is possible to provide a solid electrolyte composition that can suppress lowering in ionic conductivity of a solid electrolyte.

### BRIEF DESCRIPTION OF THE DRAWINGS

FIG. 1 is a view showing a solid electrolyte production apparatus used in Production Example 4.

### MODE FOR CARRYING OUT THE INVENTION

### [Solid Electrolyte Composition]

The solid electrolyte composition of the invention comprises a solid electrolyte that comprises Li; and

a solvent represented by the following formula (1):

R₁—(C═O)—R₂ (1)

wherein in the formula (1), R₁ and R₂ are independently a hydrocarbon group including 2 or more carbon atoms.

By containing a specific solvent, the solid electrolyte composition of the invention can prevent lowering of the ionic conductivity of a solid electrolyte or can suppress lowering of the ionic conductivity. The composition of the invention has excellent slurry retention property and slurry applicability.

Hereinbelow, each component will be explained.

### 1. Solid Electrolyte

As the solid electrolyte used in the invention, a sulfide-based solid electrolyte comprising Li, P and S is preferable. In addition to Li, P and S, this sulfide-based solid electrolyte may comprise other elements or other components or it may consist of Li, P and S.

As the other elements, a halogen element can be given. One or two or more halogen elements may be used. As the halogen element, F, Cl, Br, I and At can be given, with Br and I being preferable.

As the sulfide-based solid electrolyte comprising Li, P and S, a sulfide-based solid electrolyte obtained by using at least Li₂S as the raw material is further preferable. As the sulfide-based solid electrolyte obtained by using Li₂S as the raw material, a sulfide-based solid electrolyte obtained by using Li₂S and other sulfides as the raw materials is more preferable. As the sulfide-based solid electrolyte obtained by using Li₂S and other sulfides as the raw materials, one of which the molar ratio of Li₂S and other sulfides is 50:50 to 95:5 is particularly preferable.

As the sulfide-based solid electrolyte obtained by using Li₂S and other sulfides as the raw materials, a sulfide-based solid electrolyte obtained by using at least Li₂S and P₂S₅ as the raw materials is preferable.

As the sulfide-based solid electrolyte obtained by using at least Li₂S and P₂S₅ as the raw materials, a sulfide-based solid electrolyte of which the molar ratio of Li₂S and P₂S₅ used as the raw materials becomes Li₂S:P₂S₅=60:40 to 82:18 is preferable. A sulfide-based solid electrolyte of which the molar ratio of Li₂S and P₂S₅ is Li₂S:P₂S₅=65:35 to 82:18 is more preferable. For example, the molar ratio is Li₂S:P₂S₅=68:32 to 82:18, Li₂S:P₂S₅=72:28 to 78:22.

Further, as the sulfide-based solid electrolyte obtained by using at least Li₂S and P₂S₅ as the raw materials, a sulfide-based solid electrolyte obtained by using Li₂S and P₂S₅ as the raw materials is preferable.

As the sulfide-based solid electrolyte obtained by using Li₂S and P₂S₅ as the raw materials, a sulfide-based solid electrolyte of which the molar ratio of Li₂S and P₂S₅ used as the raw materials becomes Li₂S:P₂S₅=60:40 to 82:18 is preferable. The molar ratio of Li₂S and P₂S₅ is more preferably Li₂S:P₂S₅=65:35 to 82:18. That is, when Li, P and S contained in a sulfide-based solid electrolyte is converted to a ratio of Li₂S and P₂S₅, a sulfide-based solid electrolyte of which the molar ratio of Li₂S and P₂S₅ becomes Li₂S:P₂S₅=60:40 to 82:18 is more preferable. A sulfide-based solid electrolyte of which the molar ratio of Li₂S and P₂S₅ is Li₂S:P₂S₅=65:35 to 82:18 is preferable. The molar ratio is preferably Li₂S:P₂S₅=68:32 to 82:18, Li₂S:P₂S₅=72:28 to 78:22, for example.

The solid electrolyte may be produced by further using a halide as the raw materials in addition to Li₂S and P₂S₅. As the halide, LiI, LiBr, LiCl or the like can be given. As specific examples of the solid electrolyte obtained by using a halide as the raw material, a sulfide-based solid electrolyte comprising Li, P, S and I, a sulfide-based solid electrolyte comprising Li, P, S and Br and a sulfide-based solid electrolyte comprising Li, P, S and Cl can be given.

The ratio of the molar amount of the halide relative to the total of the molar amounts of Li₂S and P₂S₅ is preferably [Li₂S+P₂S₅]:halide=50:50 to 99:1, more preferably [Li₂S+P₂S₅]:halide=60:40 to 98:2, further preferably [Li₂S+P₂S₅]:halide=70:30 to 98:2, with [Li₂S+P₂S₅]:halide=72:28 to 98:2 being particularly preferable. For example, [Li₂S+P₂S₅]:halide=72:28 to 90:10, [Li₂S+P₂S₅]:halide=75:25 to 88:12

As specific examples of the solid electrolyte, a sulfide-based solid electrolyte such as Li₂S—P₂S₅, LiI—Li₂S—P₂S₅, LiBr—Li₂S—P₂S₅, LiCl—Li₂S—P₂S₅ and Li₃PO₄—Li₂S—Si₂S can be given.

As the solid electrolyte, one obtained by production methods such as a MM (mechanical milling) method, a melting method, a method in which raw materials are brought into contact with each other in a hydrocarbon-based solvent (WO2009/047977), a method in which allowing the raw materials to contact each other in a hydrocarbon-based solvent and synthesizing by pulverization are conducted alternatively (JP-A-2010-140893), a method in which synthesizing by pulverization is conducted after allowing the raw materials to contact with each other in a solvent (WO2013/042371) or by other production methods can be used.

The solid electrolyte mentioned above may be either amorphous (glass) or crystalline (glass ceramic).

### 2. Solvent

The solvent (ketone compound) represented by the formula (1) does not adversely affect the solid electrolyte, and it does not lower the ionic conductivity of the solid electrolyte or suppress the lowering in ionic conductivity to a minimum. Further, by using this solvent, the solid electrolyte can be a composition excellent in slurry retention property and slurry applicability.

Being excellent in slurry applicability means that a slurry (solid electrolyte) can be applied thinly and uniformly, and holes or damages are hardly generated in a coating film.

Being excellent in slurry retention property means that the slurry state is kept without causing separation of constituent raw materials of the composition when the slurry is allowed to stand.

The above-mentioned solvent serves as a dispersion medium of the solid electrolyte. The solid electrolyte may or may not be dissolved in the above-mentioned solvent partially.

Meanwhile, it is preferred that the solid electrolyte be not dissolved in the above-mentioned solvent.

Further, the above-mentioned solvent has appropriate affinity for a binder mentioned later. It partially dissolves a binder, and exhibits excellent slurry state retention property. In addition, the solvent has good dispersibility, and is excellent in slurry applicability even if a binder is added.

In the formula (1), as the hydrocarbon group of R₁ and R₂ that each include 2 or more carbon atoms, an aliphatic hydrocarbon group is preferable, with a saturated aliphatic hydrocarbon group being more preferable. As the saturated aliphatic hydrocarbon group, a chain-like saturated aliphatic hydrocarbon group is preferable, and it may be either a straight-chain saturated aliphatic hydrocarbon group or a branched saturated aliphatic hydrocarbon group.

The number of carbon atoms of R₁ and R₂ is preferably 5 or less, with 3 or less being more preferable.

R₁ and R₂ may be the same or different, but they may preferably the same.

As specific examples of the solvent represented by the formula (1), 3-pentanone (CH₃—CH₂—(C═O)—CH₂—CH₃), 3-hexanone (CH₃—CH₂—(C═O)—CH₂—CH₂—CH₃), 4-heptanone (CH₃—CH₂—CH₂—(C═O)—CH₂—CH₂—CH₃), diisopropylketone ((CH₃)₂—CH—(C═O)—CH—(CH₃)₂) or the like can be given, with 3-pentanone, 4-heptanone and diisopropylketone being particularly preferable.

The weight ratio of the solid electrolyte and the solvent mentioned above is preferably solid electrolyte:solvent=1:0.3 to 15.0, further preferably solid electrolyte:solvent=1:0.3 to 12.0, and more preferably solid electrolyte:solvent=1:0.4 to 11.0.

### 3. Binder

The solid electrolyte of the invention may further comprise a binder.

As the binder, a copolymer having a repeating unit represented by the following formula (1) and a repeating unit represented by the following formula (2) is preferable. The repeating unit represented by the formula (1) is a polymerization unit based on vinylidene fluoride (VDF) and the repeating unit represented by the formula (2) is a polymerization unit based on hexafluoropropylene (HFP).

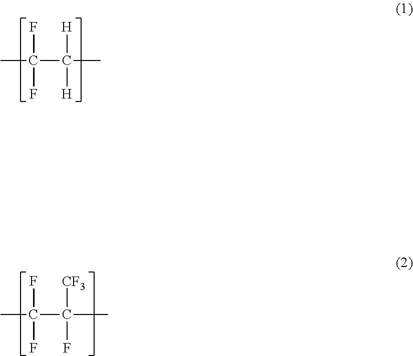

When the total weight % of the repeating units represented by the formula (1) in the binder is taken as m and the total weight % of the repeating units represented by the formula (2) in the binder is taken as n, the ratio of them preferably satisfies the following formula (A):

m:n=50 to 90:50 to 10 (A)

n and m can be obtained as follows:

m=100×(m1×m2)/(m1×m2+n1×n2)

n=100×(n1×n2)/(m1×m2+n1×n2)

In the formulas, m1 is mol % of a segment (repeating unit) represented by the formula (1) that is measured by nuclear magnetic resonance (NMR), n1 is mol % of a segment represented by the formula (2) that is measured by nuclear magnetic resonance (NMR), m2 is the molecular weight of the segment represented by the formula (1) and n2 is the molecular weight of the segment represented by the formula (2).

Meanwhile, NMR measures not mol % of each segment in a single molecule, but mol % of each segment relative to the entire binder.

The number-average molecular weight of binder molecules is preferably 1,000 to 500,000, more preferably 1,000 to 100,000, and further preferably 5,000 to 50,000.

If the number-average molecular weight of binder molecules is 1,000 to 100,000, solubility thereof in a solvent is improved, and as a result, the amount of a solvent can be reduced.

On the other hand, if the number-average molecular weight of binder molecules is 5,000 to 50,000, adhesiveness is increased, and as a result, dispersion stability or applicability of the composition of the invention is improved. As a result, a positive electrode layer can be prepared easily, for example.

As other binders, a fluorine-containing resin such as fluororubber; a thermoplastic resin such as polypropylene and polyethylene; an ethylene-propylene-diene rubber (EPDM), sulfonated EPDM, natural butyl rubber (NBR) or the like can be used singly or in a mixture of two or more. Further, a water dispersion such as cellulose-based binder or styrene butadiene rubber (SBR) as a water-based binder can also be used.

It is preferred that the weight ratio of the binder satisfy the following formula:

0.5≦100×x/y≦50

x: weight of binder in the composition
y: weight of binder+weight of solid matters other than binder in the composition

### 4. Other Components

The composition of the invention may comprise a positive electrode active material or a negative electrode active material.

A positive electrode active material is a material into which a lithium ion can be inserted and from which a lithium ion can be removed. Positive electrode active materials known in the field of a battery can be used.

As the positive electrode active material, V₂O₅, LiCoO₂, LiNiO₂, LiMnO₂, LiMn₂O₄, Li(NiₐCo_{b}Mn_{c})O₂ (wherein 0<a<1, 0<b<1, 0<c<1, a+b+c=1), LiNi_{1-Y}Co_{Y}O₂, LiCo_{1-Y}Mn_{Y}O₂, LiNi_{1-Y}Mn_{Y}O₂ (wherein 0≦Y<1), Li(NiₐCo_{b}Mn_{c})O₄ (0<a<2, 0<b<2, 0<c<2, a+b+c=2), LiMn_{2-Z}Co_{Z}O₄, LiMn_{2-Z}Co₂O₄ (wherein 0<Z<2), LiCoPO₄, LiFePO₄ or the like can be given, for example.

As the sulfide-based positive electrode active material, titanium sulfide (TiS₂), molybdenum sulfide (MoS₂), iron sulfide (FeS, FeS₂), cupper sulfide (CuS) and nickel sulfide (Ni₃S₂) or the like can be used, with TiS₂ being preferable.

As the oxide-based positive electrode active material, bismuth oxide (Bi₂O₃), bismuth plumbate (Bi₂Pb₂O₅), copper oxide (CuO), vanadium oxide (V₆O₁₃), lithium cobalt oxide (LiCoO₂), lithium nickel oxide (LiNiO₂), lithium manganese oxide (LiMnO₂) or the like can be used. It is also possible to use a mixture of these. Lithium cobalt oxide is preferably used.

It is also possible to use LiₓCoO₂, LiₓNiO₂, LiₓMn₂O₄, LiₓFePO₄, LixCoPO₄, LiₓMn_{1/3}Ni_{1/3}Co_{1/3}O₂, LiₓMn_{1.5}Ni_{0.5}O₂ or the like (X is 0.1 to 0.9).

In addition to these, niobium selenide (NbSe₃), organic disulfide compounds shown below, carbon sulfide compounds shown below, sulfur, lithium sulfide, metal indium or the like can be used as the positive electrode active material.

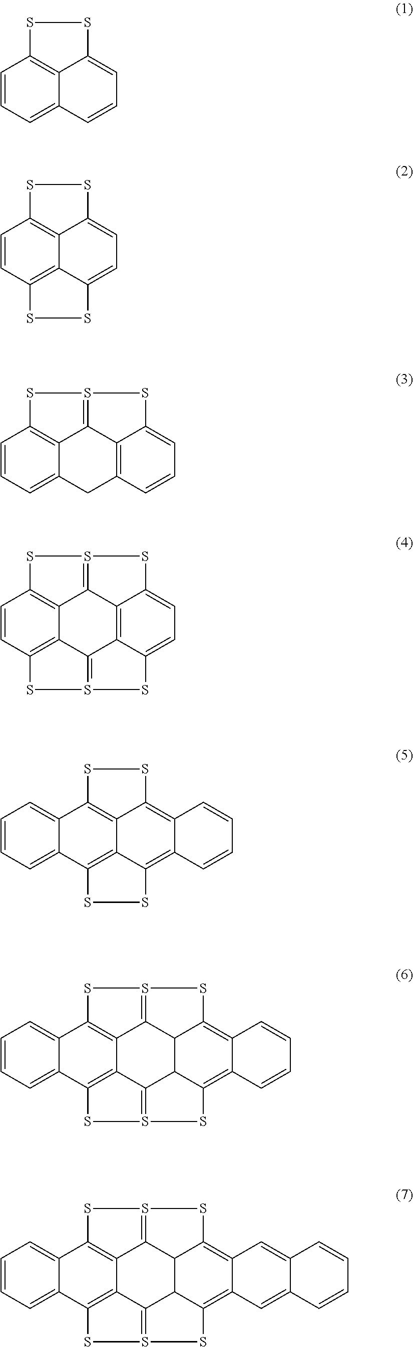

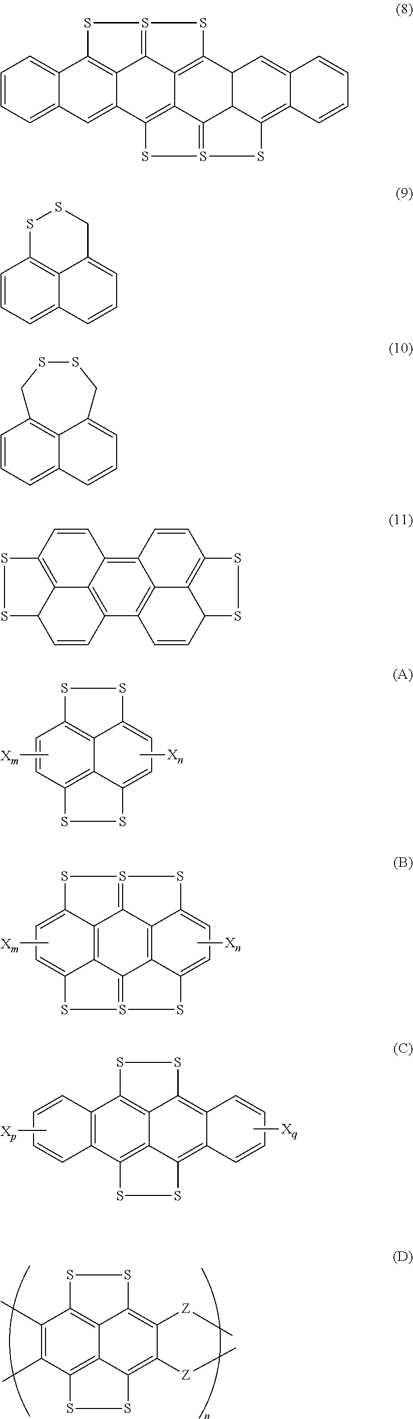

wherein in the formulas (A) to (C), Xs are independently a substituent, n and m are independently an integer of 1 to 2, and p and q are independently an integer of 1 to 4.

In the formula (D), Zs are independently —S— or —NH— and n is an integer (repeating unit) of 2 to 300.

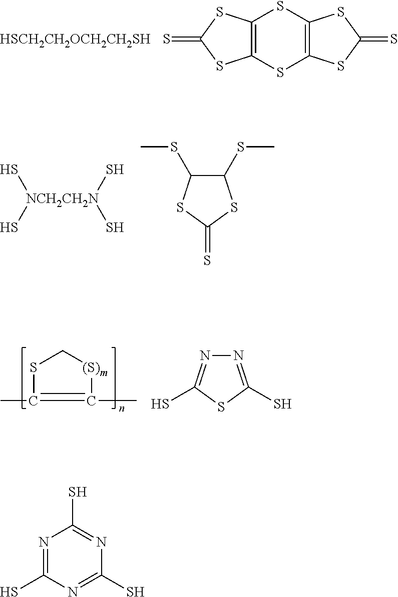

wherein in the formulas, n and m are independently an integer of 1 or more.

The composition of the invention may further comprise a conductive aid in addition to the positive electrode active material.

It suffices that the conductive aid have conductivity. The electron conductivity thereof is preferably 1×10³S/cm or more, more preferably 1×10⁵ S/cm or more. As the conductive aid, a material selected from a carbon material, metal powder and a metal compound, and a mixture thereof can be given.

As specific examples of the conductive aid, a carbon material and a material that contains at least one element selected from the group consisting of nickel, copper, aluminum, indium, silver, cobalt, magnesium, lithium, chromium, gold, ruthenium, platinum, beryllium, iridium, molybdenum, niobium, osmium, rhodium, tungsten and zinc can be given. More preferably, the conductive aid is an elemental carbon having high conductivity, a carbon material other than an elemental carbon; an elemental metal, a mixture or a compound including nickel, copper, silver, cobalt, magnesium, lithium, ruthenium, gold, platinum, niobium, osmium or rhodium.

As specific examples of the carbon material, carbon black such as ketchen black, acetylene black, denka black, thermal black and channel black; graphite, carbon fibers, activated carbon or the like can be given. These carbon materials may be used singly or in a combination of two or more. Among these, acetylene black, denka black and ketchen black having high electron conductivity are preferable.

As the negative electrode active material, a material into which a lithium ion can be inserted and from which a lithium ion can be removed and a material known in the field of a battery as the negative electrode active material can be used.

For example, carbon materials, specifically, artificial graphite, graphite carbon fibers, resin baking carbon, pyrolytic vapor-grown carbon, coke, mesocarbon microbeads (MCMB), furfuryl alcohol resin-baked carbon, polyacene, pitch-based carbon fibers, vapor-grown carbon fibers, natural graphite and non-graphitizable carbon or the like can be given. They may be used singly or in a mixture. Artificial graphite is preferable.

Further, a metal itself such as metal lithium, metal indium, metal aluminum, metal silicon or the like or alloys obtained by combining with other elements or compounds can be used as an anode material.

In addition to the negative electrode active material, the composition may comprise a conductive aid. As the conductive aid, the same materials as those mentioned above can be used.

The composition of the invention may comprise the positive electrode active material, the negative electrode active material, the conductive aid, the binder or the like mentioned above within an amount range that does not impair the advantageous effects of the invention.

The composition of the invention may comprise 90 wt % or more, 95 wt % or more and 98 wt % or more of the solid electrolyte and the solvent mentioned above. It is needless to say that, in the composition of the invention, the total of the solid electrolyte mentioned above and the solvent mentioned above may be 100 wt %.

When the composition of the invention comprises the solid electrolyte, the solvent and the binder mentioned above, it may comprise 90 wt % or more, 95 wt % or more and 98 wt % or more of the solid electrolyte, the solvent and the binder in total. In the composition of the invention, the total of the solid electrolyte mentioned above and the solvent mentioned above may be 100 wt %.

When the composition of the invention comprises the solid electrolyte, the solvent, the binder and the electrode active material (positive electrode active material or negative electrode active material), it may comprise 90 wt % or more, 95 wt % or more and 98 wt % or more of the solid electrolyte, the solvent, the binder and the electrode active material. In the composition of the invention, the total of the solid electrolyte mentioned above, the solvent mentioned above, the binder mentioned above and the electrode active material mentioned above may be 100 wt %.

Further, when the composition of the invention comprises the solid electrolyte, the solvent, the binder, the electrode active material (positive electrode active material or negative electrode active material) and the conductive aid, the same as that mentioned above can be applied. The composition may comprise 90 wt % or more, 95 wt % or more and 98 wt % or more of the solid electrolyte, the solvent, the binder and the electrode active material and the conductive aid. In the composition of the invention, the total of the solid electrolyte, the solvent, the binder, the electrode active material and the conductive aid mentioned above may be 100 wt %.

[Method for Producing Solid Electrolyte Composition]

In the method for producing a solid electrolyte composition of the invention, the above-mentioned solid electrolyte and the solvent represented by the formula (1) are mixed. The mixing method is not particularly restricted, and a known method may be used. The conditions such as the amount of the solid electrolyte, the amount of components or the like are the same as those mentioned above.

[Solid Electrolyte Containing Layer]

A solid electrolyte-containing layer can be produced by using the solid electrolyte composition of the invention. The solid electrolyte-containing layer may be composed only of the solid electrolyte, and may comprise other components mentioned above.

As the solid electrolyte-containing layer of the invention, a solid electrolyte layer, a positive electrode layer, a negative electrode layer or the like can be given.

The solid electrolyte layer of the invention is a layer which does not comprise a positive electrode active material and a negative electrode active material. That is, it comprises a solid electrolyte and, optionally, a binder or the like. The thickness of the solid electrode layer is preferably 0.01 mm or more and 10 mm or less.

The positive electrode layer of the invention is a layer that comprises the solid electrolyte and the positive active material mentioned above. The positive electrode active material is as mentioned above, and the positive electrode layer may comprise a conductive aid or a binder. The usable conductive aid or the usable binder is the same as that as mentioned above. The thickness of the positive electrode layer is preferably 0.01 mm or more and 10 mm or less.

The negative electrode layer is a layer that comprises the solid electrolyte and the negative electrode active material as mentioned above. As for the negative electrode active material, the same negative electrode active material as that mentioned above can be used. The thickness of the negative electrode layer is 0.01 mm or more and 10 mm or less.

The method for forming the solid electrolyte-containing layer is not particularly restricted as long as it is a method capable of forming a sheet-like layer. For example, a method for forming into a sheet such as press molding and roll pressing, a coating method such as doctor blading and screen printing can be given. Among these methods, it is preferable to form the layer into a sheet-like shape by a coating method.

For example, after applying the composition by using a doctor blade or the like, followed by drying to form into a sheet-like shape, the sheet-like solid electrode can be compressed by pressing, roll pressing or the like. The pressure at the time of pressing is preferably about 30 MPa to 1,000 MPa.

The temperature at the time of pressing is not particularly restricted as long as it is within a range that causes a material to be decomposed or denatured, and is normally 300° C. or less. It is preferred that the solvent in the solid electrolyte-containing layer be completely removed, but it may be remained in a slight amount. It is assumed that the solvent in the solid electrolyte-containing layer is present between solid electrolyte particles or is present in the solid electrolyte particle itself.

The solid electrolyte-containing layer can be used in a battery, in particular, a lithium secondary battery. At least one of the positive electrode layer, the electrolyte layer and the negative electrode layer may be the above-mentioned solid electrolyte-containing layer. Any one, two or all of these layers may be the above-mentioned solid electrolyte-containing layer.

[Electrolyte Layer]

The electrolyte layer of the invention comprises the solid electrolyte containing Li and comprises the solvent mentioned above that is represented by the formula (1).

The electrolyte layer of the invention is the same as the above-mentioned solid electrolyte layer, except that it comprises the solvent represented by the formula (1) as an essential component.

[Battery]

The battery of the invention comprises the electrolyte layer, the positive electrode layer and the negative electrode layer, and at least one layer of the electrolyte layer, the positive electrode layer and the negative electrode layer comprises the solid electrolyte containing Li and the solvent mentioned above that is represented by the formula (1).

It suffices that, among the positive electrode layer, the electrolyte layer and the negative electrode layer, at least one layer be the solid electrolyte containing layer mentioned above. Any one, two or all of these layers may comprise the solid electrolyte containing Li and the solvent mentioned above that is represented by the formula (1).

The electrolyte layer is a layer that does not comprise a positive electrode active material and a negative electrode active material. That is, it comprises a solid electrolyte and, optionally, a binder or the like. The thickness of the solid electrolyte layer is preferably 0.01 mm or more and 1.0 mm or less. The usable binder is the same as that mentioned above.

The positive electrode layer is a layer that comprises a positive electrode active material. The usable positive electrode active material is the same as that mentioned above. The positive electrode layer may comprise a conductive aid or a binder. The usable conductive aid or the usable binder is the same as that mentioned above. The thickness of the positive electrode layer is preferably 0.01 mm or more and 10 mm or less.

The negative electrode layer is a layer that comprises a negative electrode active material. The usable negative electrode active material is the same as that mentioned above. The thickness of the negative electrode layer is preferably 0.01 mm or more and 10 mm or less.

### EXAMPLES

### Production Example 1 [Production of Lithium Sulfide (Li₂S)]

Production and purification of lithium sulfide were conducted in the same manner as in the Examples of WO2005/040039A1. Specifically, production and purification were conducted as follows.

### (1) Production of Lithium Sulfide

In a 10 l-autoclave provided with stirring blades, 3326.4 g (33.6 mol) of N-methyl-2-pyrrolidone (NMP) and 287.4 g (12 mol) of lithium hydroxide were placed, and the temperature of the autoclave was elevated to 130° C. while stirring at 300 rpm. After the temperature was elevated, hydrogen sulfide was brown to the liquid at a supply speed of 3 l/min for 2 hours.

Subsequently, this reaction liquid was heated under nitrogen stream (200 cc/min) to remove a part of reacted hydrogen sulfide. With an increase in temperature, water generated as a side product due to the reaction of the above-mentioned hydrogen sulfide and lithium hydroxide began to evaporate. The evaporated water was condensed using a condenser and removed to the outside the system. Since the temperature of the reaction liquid elevated while water was distilled away out of the system, heating was stopped at the point where the temperature reached 180° C. to maintain a certain temperature. After the completion of hydrogen sulfide removal (about 80 minutes), the reaction was completed to obtain lithium sulfide.

### (2) Purification of Lithium Sulfide

After NMP in the 500-mL slurry reaction solution (NMP-lithium sulfide slurry) obtained in the above-mentioned (1) was subjected to decantation, 100 mL of dehydrated NMP was added thereto. Then, the mixture was stirred at 105° C. for about one hour. With the temperature being maintained, NMP was subjected to decantation. Further, 100 mL of NMP was added and stirred at 105° C. for about one hour, and NMP was subjected to decantation with the temperature being maintained. The same operation was repeated 4 times in total. After the completion of the decantation, lithium sulfide was dried at 230° C. (which is a temperature higher than the boiling point of NMP) under nitrogen stream and under ordinary pressure for 3 hours. The content of impurities contained in lithium sulfide obtained was measured.

The contents of sulfur oxides of lithium sulfite (Li₂SO₃), lithium sulfate (Li₂SO₄) and thiosulfuric acid dilithium salt (Li₂S₂O₃), and N-methylaminobutyric acid lithium salt (LMAB) were quantitated by means of ion chromatography. As a result, the total content of sulfur oxides was 0.13 wt %, and the content of LMAB was 0.07 wt %.

### Production Example 2 [Production of Solid Electrolyte 1 (Sulfur-Based Solid Electrolyte: Li₂S:P₂S₅=70:30 (Mol)]

A solid electrolyte was produced and crystallized by using lithium sulfide which had been produced in Production Example 1 according to the method described in Example 1 in WO07/066539.

Specifically, production and crystallization were conducted as follows.

0.6508 g (0.01417 mol) of lithium sulfide which had been produced in Production Example 1 and 1.3492 g (0.00607 mol) of phosphorus pentasulfide (manufactured by Sigma-Aldrich Co. LLC.) were sufficiently mixed. The mixed powder, 10 zirconia balls each having a diameter of 10 mm and a planetary ball mill (P-7, manufactured by Fritsch) were charged in an alumina pot. The pot was completely sealed and was filled with nitrogen, thereby to attain nitrogen atmosphere.

For the initial several minutes, lithium sulfide and phosphorus pentasulfide were sufficiently mixed with the planetary ball mill being rotated at a low speed (85 rpm). Then, the rotation speed of the planetary ball mill was gradually raised until 370 rpm. The mechanical milling was conducted for 20 hours at a rotation speed of the planetary ball mill of 370 rpm to obtain white-yellow powder. As a result of evaluation of the white-yellow powder that was subjected to mechanical milling, it could be confirmed that the powder was vitrified (glass sulfide). The glass transition temperature of the sulfide glass was measured by DSC (differential scanning calorimetry), and was found to be 220° C.

This sulfide glass was heated at 300° C. for 2 hours in a nitrogen atmosphere, whereby sulfide glass ceramics was obtained.

72 g of the resulting sulfide glass ceramics and 100 g of toluene were stirred at 200 rpm for 2 hours by using a planetary ball mill LP-4 (manufactured by ITO Seisakusho Co., Ltd.) and Zr balls (diameter: 10 mm, 743 g), whereby electrolyte particles 1 were obtained.

These electrolyte particles 1 (sulfide glass ceramics) were subjected to an X-ray diffraction measurement. As a result, a peak was observed at 29=17.8, 18.2, 19.8, 21.8, 23.8, 25.9, 29.5 and 30.0 deg.

The average particle diameter of the electrolyte particles 1 was 8.8 μm. The ionic conductivity was 6.36×10⁻⁴ S/cm.

### Production Example 3 [Production of Solid Electrolyte 2 (Sulfur-Based Solid Electrolyte: Li₂S:P₂S₅=75:25 (Mol)]

Electrolyte particles 2 were produced in the same manner as in Production Example 2, except that the amount of high-purity lithium sulfide that had been produced and purified in Production Example 1 was changed to 0.766 g (0.0166 mol) and the amount of phosphorus pentasulfide (manufactured by Sigma-Aldrich Co. LLC.) was changed to 1.22 g (0.0055 mol) and no heating at 300° C. for 2 hours was conducted.

For the obtained electrolyte particles 2, an X-ray measurement was conducted to confirm that they were vitrified. The average particle size of the electrolyte particles 2 was 11.2 μm. Ionic conductivity was 1.22×10⁻⁴ S/cm.

### Production Example 4

Solid electrolyte 3 (sulfur-based solid electrolyte Li₂S:P₂S₅: LiBr=64:21:15 (mol)) was produced according to Example 3 of WO2014/010169.

Specifically, the production was conducted as follows.

### [Production of Lithium Sulfide (Li₂S)]

Under the flow of nitrogen, 270 g of toluene as a non-polar solvent was placed in a 600 ml-separable flask. Then, 30 g of lithium hydroxide (manufactured by Honjo Chemical Corporation) was placed. While stirring by means of a full-zone stirring blade at 300 rpm, the resulting slurry was retained at 95° C. While blowing hydrogen sulfide at a supply speed of 300 ml/min into the slurry, the slurry was heated to 104° C. From the separable flask, an azeotropic gas of water and toluene was continuously discharged. This azeotropic gas was dehydrated by condensing by a condenser outside the system. During that period, toluene in an amount similar to that of the toluene that was distilled off was continuously supplied, whereby the reaction liquid level was kept at constant.

The amount of the water in the condensed liquid was gradually decreased. After the lapse of 6 hours from the start of the introduction of hydrogen sulfide, distillation off of water was no longer observed (the water content was 22 ml in total). During the reaction, the solids were in the state that they were dispersed and stirred in the toluene, and no water phase was separated from the toluene. Thereafter, the hydrogen sulfide was changed to nitrogen, and the nitrogen was flown at a speed of 300 ml/min for one hour. The solid matters were filtrated and dried to obtain lithium sulfide as white powder.

The resulting powder was analyzed by titration with hydrochloric acid and titration with silver nitrate. As a result, it was found that the purity of lithium sulfide was 99.0%. Further, as a result of an X-ray diffraction measurement, it was confirmed that a peak derived from other than the crystal patterns of lithium sulfide was not detected. The average particle size was 450 μm (slurry solution).

The specific surface area of the resulting lithium sulfide was measured by the BET method with a nitrogen gas by means of AUTOSORB 6 (manufactured by Sysmex Corporation), and found to be 14.8 m²/g. The fine pore volume was measured by using the same apparatus as that for measuring the specific surface area, and obtained by interpolating to 0.99 from a measuring point at which the relative pressure (P/P₀) is 0.99 or more. The fine pore volume was found to be 0.15 ml/g.

[Production of Solid Electrolyte 3 (Sulfur-Based Solid Electrolyte Li₂S:P₂S₅:LiBr=64:21:15 (Mol))

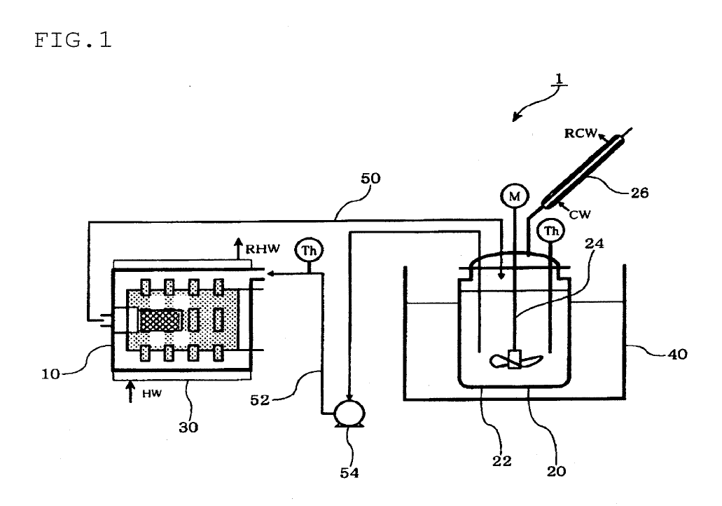

The apparatus shown in FIG. 1 was used.

A production device 1 is provided with a pulverizer 10 that synthesizes an ion conductive material while pulverizing raw materials in a solvent and a temperature-keeping chamber 20 that allows raw materials to contact in the solvent. The temperature-keeping chamber 20 is provided with a container 22 and a stirring blade 24. The stirring blade 24 is driven by a motor (M).

The pulverizer 10 is provided with a heater 30 that enables warm water to pass around the pulverizer 10 in order to keep the inside of the pulverizer 10 to be 20° C. or higher and 80° C. or lower. In order to keep the inside of the temperature-keeping chamber 20 to be 60° C. or higher and 300° C. or lower, the temperature-keeping chamber 20 is accommodated within an oil bath 40. The oil bath 40 heats the raw materials and the solvent in the container 22 to a prescribed temperature. A cooling tube 26 that cools and liquefies an evaporated solvent is provided in the temperature-keeping chamber 20.

The pulverizer 10 and the temperature-keeping chamber 20 are linked by a first linking tube 50 and a second linking tube 52. The first linking tube 50 serves to move the raw materials and the solvent in the pulverizer 10 to the temperature-keeping chamber 20, and the second linking tuber 52 serves to move the raw materials and the solvent in the temperature-keeping chamber 20 to the pulverizer 10. In order to allow the raw materials or the like to circulate by passing them through the linking tubes 50 and 52, a pump 54 is provided in the second linking tube 52.

As the stirrer 10, “Star Mill Miniature” (0.15 L) (beads mill) manufactured by Ashizawa Finetech Ltd.) was used. 444 g of zirconia balls each having a diameter of 0.5 mm were charged. As the temperature-keeping chamber 20, a 1.5 L-glass made reactor provided with a stirrer was used.

The weighing, addition and sealing were conducted in a glove box in an atmosphere of nitrogen. Water was removed from all of the tools used in advance. The amount of water in dehydrated toluene was 8.4 ppm measured according to water measurement by a Karl Fischer method.

To 33.7 g (64 mol %) of lithium sulfide mentioned above, 53.2 g (21 mol %) of P₂S₅ (manufactured by Sigma-Aldrich Co. LLC.) and 14.1 g (15 mol %) of LiBr (manufactured by Sigma-Aldrich Co. LLC.), 1248 ml (water amount: 8.4 ppm) was added. The resulting mixture was filled in the temperature-keeping chamber 20 and the mill 10.

By means of a pump 54, the content was circulated between the temperature-keeping chamber 20 and the mill 10 at a flow rate of 480 ml/min, and the temperature of the temperature-keeping chamber was elevated to 70 to 80° C.

In the mill main body, warm water was passed by external circulation such that the liquid temperature could be kept at 70° C. The mill was operated at a circumferential speed of 12 m/s. Every two hours, a slurry was taken out, dried at 150° C., whereby white yellow powder slurry (creamy) was obtained. The resulting slurry was filtered and air-dried, and dried at 160° C. for 2 hours by means of a tube heater, whereby a solid electrolyte was obtained as powder. The yield was 95% and no adhered matters were observed in the reactor.

Circulation was continued until the peak derived from lithium sulfide became sufficiently smaller than that of a halo pattern derived from solid electrolyte glass in an X-ray diffraction measurement (CuKα:λ=1.5418 Å) of the resulting powder. The reaction time was 24 hours. The ionic conductivity of the resulting glass was 5.2×10⁻⁴ S/cm.

The solid electrolyte powder mentioned above was sealed in a SUS-made tube in a glove box in an atmosphere of Ar. A heating treatment was conducted at 230° C. for 2 hours, whereby solid electrolyte glass ceramic was obtained.

The ionic conductivity of this electrolyte glass ceramic was 1.8×10⁻³ S/cm.

### Example 1

### Preparation of Solid Electrolyte Composition

1 g of the solid electrolyte 2, 9 g of 4-heptanone was added and stirred for 3 hours by means of a magnet stirrer. Then, the resultant was heated to 150° C. and again stirred for 1 hour by means of a magnet stirrer, whereby a composition was prepared.

### [Measurement of Ionic Conductivity]

The composition obtained above was dried to remove the solvent therefrom, thereby to obtain a sample. The sample was filled in a tablet molding machine and a pressure of 360 MPa was applied to obtain a molded product. Further, carbon paste was applied on the both surfaces of the molded product, followed by drying, whereby an electrode was formed. As a result, a molded product (diameter: about 10 mm, thickness: about 1 mm) for measuring conductivity was formed. For this molded product, the ionic conductivity thereof was measured by the alternating current impedance method by using an alternate impedance measurement apparatus (manufactured by Nihon Solaton Co., Ltd.). The results are shown in Table 1.

### Example 2

A composition was prepared and evaluated in the same manner as in Example 1, except that the solvent was changed from 4-heptanone to 3-pentanone. The results are shown in Table 1.

### Comparative Example 1

A composition was prepared and evaluated in the same manner as in Example 1, except that the solvent was changed from 4-heptanone to 2-butanone. The results are shown in Table 1.

### Comparative Example 2

A composition was not prepared. The solid electrolyte 2 was filled in a tablet molding machine, and a pressure of 360 MPa was applied to obtain a molded product. Further, carbon paste was applied on the both surfaces of the molded product, followed by drying, whereby an electrode was formed. As a result, a molded product (diameter: about 10 mm, thickness: about 1 mm) for measuring conductivity was formed. For this molded product, the ionic conductivity thereof was measured in the same manner as in Example 1. The results are shown in Table 1.

TABLE 1

| | | | Ionic conductivity |
|---|---|---|---|
| | Solid electrolyte | Solvent | (S/cm) |
| Example 1 | Solid electrolyte 2 | 4-heptanone | 1.5 × 10⁻⁴ |
| Example 2 | Solid electrolyte 2 | 3-pentanone | 1.1 × 10⁻⁴ |
| Comp. Ex. 1 | Solid electrolyte 2 | 2-butanone | 0.4 × 10⁻⁴ |
| Comp. Ex. 2 | Solid electrolyte 2 | No treatment with | 1.2 × 10⁻⁴ |
| | | solvent | |

### Example 3

A composition was prepared and evaluated in the same manner as in Example 1, except that the solid electrolyte 2 was changed to the solid electrolyte 1. The results are shown in Table 2.

### Example 4

A composition was prepared and evaluated in the same manner as in Example 3, except that the solvent was changed from 4-heptanone to 3-pentanone. The results are shown in Table 2.

### Comparative Example 3

A composition was prepared and evaluated in the same manner as in Example 3, except that the solvent was changed from 4-heptanone to 2-butanone. The results are shown in Table 2.

### Comparative Example 4

Only the measurement of the ionic conductivity of the solid electrolyte 1 was conducted without preparing a composition. The results are shown in Table 2.

TABLE 2

| | | | Ionic conductivity |
|---|---|---|---|
| | Solid electrolyte | Solvent | (S/cm) |
| Example 3 | Solid electrolyte 1 | 4-heptanone | 1.0 × 10⁻³ |
| Example 4 | Solid electrolyte 1 | 3-pentanone | 0.9 × 10⁻³ |
| Comp. Ex. 3 | Solid electrolyte 1 | 2-butanone | 0.4 × 10⁻⁴ |
| Comp. Ex. 4 | Solid electrolyte 1 | No treatment with | 1.1 × 10⁻³ |
| | | solvent | |

### Example 5

A composition was prepared and evaluated in the same manner as in Example 1, except that the solvent was changed from the solid electrolyte 2 was changed to the solid electrolyte 3. The results are shown in Table 3.

### Example 6

A composition was prepared and evaluated in the same manner as in Example 5, except that the solvent was changed from 4-heptanone to 3-pentanone. The results are shown in Table 3.

### Comparative Example 5

A composition was prepared in the same manner as in Example 5, except that the solvent was changed from 4-heptanone to 2-butanone. The results are shown in Table 3.

### Comparative Example 6

Only the measurement of the ionic conductivity of the solid electrolyte 3 was conducted without preparing a composition. The results are shown in Table 3.

### Example 7

A composition was prepared in the same manner as in Example 5, except that the solvent was changed from 4-heptanone to diisopropyl ketone. The results are shown in Table 3.

### Comparative Example 7

A composition was prepared in the same manner as in Example 5, except that the solvent was changed from 4-heptanone to triethylamine. Evaluation was attempted to be conducted. However, the ionic conductivity could not be measured.

### Comparative Example 8

A composition was prepared in the same manner as in Example 5, except that the solvent was changed from 4-heptanone to γ-butyrolacton. Evaluation was attempted to be conducted. However, the ionic conductivity could not be measured.

### Comparative Example 9

A composition was prepared in the same manner as in Example 5, except that the solvent was changed from 4-heptanone to 1,4-dioxane. Evaluation was attempted to be conducted. However, the ionic conductivity could not be measured.

### Comparative Example 10

A composition was prepared in the same manner as in Example 1, except that the solvent was changed from 4-heptanone to cyclohexanone. Evaluation was attempted to be conducted. However, the ionic conductivity could not be measured.

TABLE 3

| | | | Ionic |
|---|---|---|---|
| | | | conductivity |
| | Solid electrolyte | Solvent | (S/cm) |
| Example 5 | Solid electrolyte 3 | 4-heptanone | 1.0 × 10⁻³ |
| Example 6 | Solid electrolyte 3 | 3-pentanone | 1.3 × 10⁻³ |
| Example 7 | Solid electrolyte 3 | Diisopropylketone | 1.3 × 10⁻³ |
| Comp. Ex. 5 | Solid electrolyte 3 | 2-butanone | 0.6 × 10⁻⁴ |
| Comp. Ex. 6 | Solid electrolyte 3 | No treatment with | 1.1 × 10⁻³ |
| | | solvent | |
| Comp. Ex. 7 | Solid electrolyte 3 | Triethylamine | Not measurable |
| Comp. Ex. 8 | Solid electrolyte 3 | γ-butyrolactone | Not measurable |
| Comp. Ex. 9 | Solid electrolyte 3 | 1,4-dioxane | Not measurable |
| Comp. Ex. 10 | Solid electrolyte 2 | Cyclohexanone | Not measurable |

From the results shown in Tables 1 to 3, it can be understood that the composition of the invention obtained by using a specific solvent does not substantially lower the ionic conductivity of the solid electrolyte

### INDUSTRIAL APPLICABILITY

The solid electrolyte composition of the invention can be used in a solid electrolyte for a lithium secondary battery. Further, a lithium secondary battery can be used as a lithium secondary battery used in a personal digital assistant, a portable electronic device, a household small power storage device, an automatic bicycle powered by a motor, an electric car, a hybrid electric car or the like.

Although only some exemplary embodiments and/or examples of this invention have been described in detail above, those skilled in the art will readily appreciate that many modifications are possible in the exemplary embodiments and/or examples without materially departing from the novel teachings and advantages of this invention. Accordingly, all such modifications are intended to be included within the scope of this invention.

The documents described in the specification and the Japanese patent applications claiming the priority under the Paris Convention to the invention are incorporated herein by reference in its entirety.

1. A solid electrolyte composition comprising:
a solid electrolyte that comprises Li; and
a solvent represented by the following formula (1):
R₁—(C═O)—R₂ (1)
wherein in the formula (1), R₁ and R₂ are independently a hydrocarbon group including 2 or more carbon atoms.

2. The solid electrolyte composition according to claim 1, wherein R₁ and R₂ are independently an aliphatic hydrocarbon group.

3. The solid electrolyte composition according to claim 2, wherein R₁ and R₂ are independently a saturated aliphatic hydrocarbon group.

4. The solid electrolyte composition according to claim 3, wherein R₁ and R₂ are independently a chain-like saturated aliphatic hydrocarbon group.

5. The solid electrolyte according to claim 1, wherein R₁ and R₂ are the same.

6. The solid electrolyte composition according to claim 1, wherein R₁ and R₂ are independently a straight-chain saturated aliphatic hydrocarbon group.

7. The solid electrolyte composition according to claim 4, wherein R₁ and R₂ are independently a hydrocarbon group including 5 or less carbon atoms.

8. The solid electrolyte composition according to claim 4, wherein R₁ and R₂ are independently a hydrocarbon group including 3 or less carbon atoms.

9. The solid electrolyte composition according to claim 7, wherein the solid electrolyte comprises Li, P and S.

10. The solid electrolyte composition according to claim 9, wherein, when Li, P and S are converted into Li₂S and P₂S₅, the molar ratio of Li₂S and P₂S₅ is Li₂S:P₂S₅=60:40 to 82:18.

11. The solid electrolyte composition according to claim 7, wherein the weight ratio of the solid electrolyte and the solvent is solid electrolyte:solvent=1:0.3 to 15.0.

12. The solid electrolyte composition according to claim 7, which further comprises a binder.

13. The solid electrolyte composition according to claim 12, wherein the binder is a copolymer comprising a polymerization unit based on vinylidene fluoride and a polymerization unit based on hexafluoropropylene.

14. A method for producing a solid electrolyte composition according to claim 1, which comprises mixing a solid electrolyte that comprises Li and a solvent represented by the following formula (1):
R₁—(C═O)—R₂ (1)
wherein in the formula (1), R₁ and R₂ are independently a hydrocarbon group including 2 or more carbon atoms.

15-16. (canceled)

17. A method for producing a solid electrolyte-containing layer, which comprises using the solid electrolyte composition according to claim 1.

18. An electrolyte layer comprising a solid electrolyte which comprises Li, wherein said electrolyte layer comprises a solvent represented by the following formula (1):
R₁—(C═O)—R₂ (1)
wherein in the formula (1), R₁ and R₂ are independently a hydrocarbon group including 2 or more carbon atoms.

19. A battery which comprises an electrolyte layer, a positive electrode layer and a negative electrode layer, wherein at least one layer of the electrolyte layer, the positive electrode layer and the negative electrode layer comprises a solid electrolyte comprising Li and a solvent represented by the following formula (1):
R₁—(C═O)—R₂ (1)
wherein in the formula (1), R₁ and R₂ are independently a hydrocarbon group including 2 or more carbon atoms.

20. The solid electrolyte composition according to claim 4, wherein R₁ and R₂ are the same.

21. The solid electrolyte composition according to claim 6, wherein R₁ and R₂ are the same.

22. The solid electrolyte composition according to claim 9, wherein the weight ratio of the solid electrolyte and the solvent is solid electrolyte:solvent=1:0.3 to 15.0.
